(19) United States
(12) Patent Application Publication
(10) Pub. No.: US 2026/0349885 A1
(43) Pub. Date: Nov. 5, 2026

(54) Virtual Controller Redundancy Configuration Method and Apparatus

(71) Applicant: Siemens Aktiengesellschaft, München (DE)

(72) Inventors: Yao Lei Kang, Peking, BJ (CN); Dong Li, Peking, BJ (CN); Chuan Yu Zhang, Peking, BJ (CN)

(73) Assignee: Siemens Aktiengesellschaft, München (DE)

(21) Appl. No.: 19/485,893

(22) PCT Filed: May 31, 2023
(86) PCT No.: PCT/CN2023/097561

§ 371 Date: Nov. 19, 2025

(51) Int. Cl. G06F 11/1482; G05B 19/042

(52) U.S. Cl. CPC G06F 11/1482; G05B 19/0425; G06F 2201/815

(57) ABSTRACT

Some embodiments of the teachings herein include a virtual controller redundancy configuration method. An example includes: starting a controller instance, and initializing a score value thereof; acquiring input and intermediate data of each controller instance, obtaining output data and new intermediate data of each instance by calculating based on the input data and the intermediate data, and updating the intermediate data by the new intermediate data; evaluating the instances respectively based on the output data of each instance to obtain a score change value of each, updating the score value according to the score change value, and selecting the instance with a highest score value as a main instance; outputting the output data of the main controller instance; and repeating acquiring input data and succeeding limitations for a new round of calculations.

### CROSS-REFERENCE TO RELATED APPLICATIONS

This application is a U.S. National Stage Application of International Application No. PCT/CN2023/097561 filed May 31, 2023, which designates the United States of America, the contents of which are hereby incorporated by reference in their entirety.

### TECHNICAL FIELD

The present disclosure relates to edge computing and cloud computing. Various embodiments of the teachings herein include virtual controller redundancy configuration methods and apparatus.

### BACKGROUND

At present, bringing the information technology into industrial automation is more and more popular, especially in the context of edge computing or cloud computing. One of the most important features for industrial controllers is high availability. Traditional industrial controllers, such as PLCs, usually meet a requirement of high availability through redundancy of customized hardware and devices. However, in the context of the edge computing or cloud computing, the controller may be located in IPC, public cloud, private cloud, or the like, and the edge controllers or the cloud controllers may exist in a server as a virtual or soft controller in a form of software services.

### SUMMARY

The present disclosure describes systems and methods to ensure the high availability of the edge controllers or cloud controllers and reduce costs of the devices. For example, some embodiments include virtual controller redundancy configuration methods and/or apparatus to ensure high availability of a controller instance and reduce hardware consumption.

As an example, some embodiments include a virtual controller redundancy configuration method (100) comprising:
an initialization step (S101) comprising: starting at least one controller instance, and initializing a score value of the controller instance;
a calculation step (S102) comprising: acquiring input data and intermediate data of each controller instance, obtaining output data and new intermediate data of each controller instance by calculating respectively based on the input data and the intermediate data, and updating the intermediate data by the new intermediate data;
a controller instance selection step (S103) comprising: evaluating the controller instances respectively based on the output data of each controller instance to obtain a score change value of each controller instance, updating the score value of each controller instance according to the score change value, and selecting the controller instance with a highest score value as a main controller instance; and
an output step (S104) comprising: outputting the output data of the main controller instance, and returning to the calculation step (S102) for a new round of calculation.

In some embodiments, the method further comprises a controller instance error synchronization step (S105) comprising: updating, in a case that the score value of one controller instance is lower than a preset error score, the intermediate data of the controller instance by the intermediate data of other controller instances, and updating an error count of the controller instance.

In some embodiments, the method further comprises: a controller instance error reset step (S106) comprising: resetting, in a case that the error count of one controller instance reaches the preset number of error times, the score value and the error count of the controller instance, restarting the controller instance, and updating the intermediate data of the controller instance by the intermediate data of other controller instances.

In some embodiments, the method further comprises: a controller instance off-line reset step (S107) comprising: resetting, in a case that the number of times that one controller instance does not generate output data reaches the preset number of off-line times, the score value and the error count of the controller instance, restarting the controller instance, and updating the intermediate data of the controller instance by the intermediate data of other controller instances.

As another example, some embodiments include a virtual controller redundancy configuration apparatus (200) comprising: an initialization module (201) configured to: start at least one controller instance, and initialize a score value of the controller instance; a calculation module (202) configured to: acquire input data and intermediate data of each controller instance, obtain output data and new intermediate data of each controller instance by calculating respectively based on the input data and the intermediate data, and update the intermediate data by the new intermediate data; a controller instance selection module (203) configured to: evaluate the controller instances respectively based on the output data of each controller instance to obtain a score change value of each controller instance, update the score value of each controller instance according to the score change value, and select the controller instance with a highest score value as a main controller instance; and an output module (204) configured to: output the output data of the main controller instance, and return to and execute the calculation module (202) for a new round of calculation.

In some embodiments, the apparatus further comprises a controller instance error synchronization module (205) configured to: update, in a case that the score value of one controller instance is lower than a preset error score, the intermediate data of the controller instance by the intermediate data of other controller instances, and update an error count of the controller instance.

In some embodiments, the apparatus further comprises a controller instance error reset module (206), configured to: reset, in a case that the error count of one controller instance reaches the preset number of error times, the score value and the error count of the controller instance, restart the controller instance, and update the intermediate data of the controller instance by the intermediate data of other controller instances.

In some embodiments, the apparatus further comprises a controller instance off-line reset module (207), configured to: reset, in a case that the number of times that one controller instance does not generate output data reaches the preset number of off-line times, the score value and the error count of the controller instance, restart the controller instance, and update the intermediate data of the controller instance by the intermediate data of other controller instances.

As another example, some embodiments include an electronic device (300) comprising: at least one processor (310); and a memory (320) coupled to the at least one processor (310), the memory (320) being configured to store an instruction, and the instruction, when executed by the at least one processor (310), causing the processor (310) to execute one or more of the methods described herein.

As another example, some embodiments include a computer-readable storage medium, storing a computer instruction, the computer instruction, when run, executing one or more of the methods described herein.

As another example, some embodiments include a computer program product, comprising a computer program, the computer program, when executed by a processor, implementing one or more of the methods described herein.

### BRIEF DESCRIPTION OF THE DRAWINGS

The following drawings are intended to give schematic illustrations and explanations of the present disclosure but are not intended to limit the scope of the present disclosure. In the drawings:

FIG. 1 is a flowchart of an example virtual controller redundancy configuration method incorporating teachings of the present disclosure;

FIG. 2 is a schematic structural diagram of an example virtual controller redundancy configuration apparatus incorporating teachings of the present disclosure; and

FIG. 3 is a schematic diagram of an example electronic device incorporating teachings of the present disclosure.

Reference numerals are described as follows:

| Serial numerals | Meanings |
|---|---|
| 100 | Virtual controller redundancy |
| | configuration method |
| S101 | Initialization step |
| S102 | Calculation step |
| S103 | Controller instance selection step |
| S104 | Output step |
| S105 | Controller instance error |
| | synchronization step |
| S106 | Controller instance error reset step |
| S107 | Controller instance off-line reset |
| | step |
| 200 | Virtual controller redundancy |
| | configuration apparatus |
| 201 | Initialization module |
| 202 | Calculation module |
| 203 | Controller instance selection module |
| 204 | Output module |
| 205 | Controller instance error |
| | synchronization module |
| 206 | Controller instance error reset module |
| 207 | Controller instance off-line reset |
| | module |
| 300 | Electronic device |
| 310 | Processor |
| 320 | Memory |

### DETAILED DESCRIPTION

An example embodiment of the present disclosure includes a virtual controller redundancy configuration method comprising: an initialization step, including: starting at least one controller instance, and initializing a score value of the controller instance; a calculation step, including: acquiring input data and intermediate data of each controller instance, obtaining output data and new intermediate data of each controller instance by calculating respectively based on the input data and the intermediate data, and updating the intermediate data by the new intermediate data; a controller instance selection step, including: evaluating the controller instances respectively based on the output data of each controller instance to obtain a score change value of each controller instance, updating the score value of each controller instance according to the score change value, and selecting the controller instance with a highest score value as a main controller instance; and an output step, including: outputting the output data of the main controller instance, and returning to the calculation step for a new round of calculation. In this way, redundancy backup of the controller instances may be achieved, the high availability of the controller instances may be ensured, and the hardware consumption may be reduced.

In some embodiments, the method further includes: a controller instance error synchronization step, including: updating, in a case that the score value of one controller instance is lower than a preset error score, the intermediate data of the controller instance by the intermediate data of other controller instances, and updating an error count of the controller instance. In this way, automatic error correction for abnormal controller instances is achieved, error accumulation of the intermediate data is avoided, a health state of an overall controller instance cluster is ensured, and then a control effect is ensured.

In some embodiments, the method further includes: a controller instance error reset step, including: resetting, in a case that the error count of one controller instance reaches the preset number of error times, the score value and the error count of the controller instance, restarting the controller instance, and updating the intermediate data of the controller instance by the intermediate data of other controller instances. In this way, restarting for repeatedly abnormal controller instances is achieved, a health state of the overall controller instance cluster is ensured, and serious errors in the controller instances are further avoided.

In some embodiments, the method further includes: a controller instance off-line reset step, including: resetting, in a case that the number of times that one controller instance does not generate output data reaches the preset number of off-line times, the score value and the error count of the controller instance, restarting the controller instance, and updating the intermediate data of the controller instance by the intermediate data of other controller instances. In this way, restarting for off-line controller instances is achieved, a health state of the overall controller instance cluster is ensured, and then a control effect is ensured.

Some embodiments of the present disclosure include a virtual controller redundancy configuration apparatus, including: an initialization module, configured to: initialize a score value of at least one controller instance; a calculation module, configured to: acquire input data and intermediate data of each controller instance, obtain output data and new intermediate data of each controller instance by calculating respectively based on the input data and the intermediate data, and update the intermediate data by the new intermediate data; a controller instance selection module, configured to: evaluate the controller instances respectively based on the output data of each controller instance to obtain a score change value of each controller instance, update the score value of each controller instance according to the score change value, and select the controller instance with a highest score value as a main controller instance; and an output module, configured to: output the output data of the main controller instance, and return to and execute the calculation module for a new round of calculation. Redundancy backup of the controller instances is achieved, the high availability of the controller instances is ensured, and the hardware consumption is reduced.

Some embodiments include an electronic device, including: at least one processor; and a memory coupled to the at least one processor, the memory being configured to store an instruction, and the instruction, when executed by the at least one processor, causing the processor to execute one or more of the methods described herein.

Some embodiments include a computer-readable storage medium, storing a computer instruction, the computer instruction, when run, executing one or more of the methods described in herein.

Some embodiments include a computer program product, including a computer program, the computer program, when executed by a processor, implementing one or more of the methods described herein.

In order to provide a clearer understanding of the technical features, objectives, and effects of the present disclosure, specific implementations of the present disclosure are described with reference to the accompanying drawings. Many specific details are set forth in the following description to facilitate a full understanding of the present disclosure, but the present disclosure may alternatively be implemented in other manners different from those described herein and is therefore not limited by specific embodiments disclosed below.

As shown in this application and the claims, words such as “a/an,” “one,” “one kind,” and/or “the” do not refer specifically to singular forms and may also include plural forms, unless the context expressly indicates an exception. In general, terms “comprise” and “include” merely indicate including clearly identified steps and elements. These steps and elements do not constitute an exclusive list. A method or a device may also include other steps or elements.

When considering redundancy of a controller to ensure high availability, it usually means that more than one controller instance is required and running a plurality of virtual or soft controller instances on one piece of hardware naturally saves more hardware costs compared to a mode of simple hardware controller backup. In some embodiments, on the basis of running a plurality of virtual or soft controller instances on one device, a more optimized virtual controller redundancy configuration solution is provided.

In some embodiments, the a score value of at least one controller instance is initialized; input data and intermediate data of each controller instance are acquired, output data and new intermediate data of each controller instance are obtained by calculating respectively based on the input data and the intermediate data, and the intermediate data is updated by the new intermediate data; the controller instances are evaluated respectively based on the output data of each controller instance to obtain a score change value of each the score value of each controller instance is updated according to the score change value, and the controller instance with a highest score value is selected as a main controller instance; and the output data of the main controller instance is outputted, and returning is performed to perform a new round of calculation. A virtual controller redundancy solution with high availability can be provided, and additional hardware consumption is reduced.

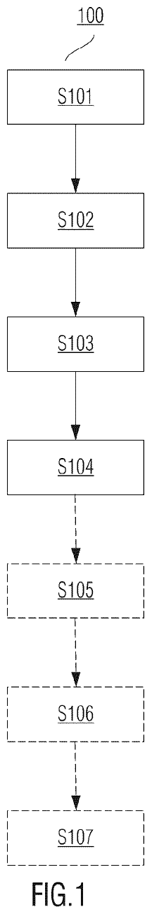

FIG. 1 is a schematic flowchart of an example virtual controller redundancy configuration method 100 incorporating teachings of the present disclosure. As shown in FIG. 1, the method 100 may include:
an initialization step S101 including: starting at least one controller instance, and initializing a score value of the controller instance.

In some embodiments, when the controller instance is initialized and started, its score value may be a full score of 100 points, an upper limit is 100, and the quantity of the controller instances may be an odd number greater than 1, specifically 5.

A calculation step S102 including: acquiring input data and intermediate data of each controller instance, obtaining output data and new intermediate data of each controller instance by calculating respectively based on the input data and the intermediate data, and updating the intermediate data by the new intermediate data.

In some embodiments, the data may be acquired based on a publish-subscribe pattern, the input data of the hardware may be received through an input module and published, the controller instance subscribes the input module to acquire the input data, and the output data of 5 controller instances specifically may be: 60, 59.9, 60.1, 60 and 70.

A controller instance selection step S103 including: evaluating the controller instances respectively based on the output data of each controller instance to obtain a score change value of each controller instance, updating the score value of each controller instance according to the score change value, and selecting the controller instance with a highest score value as a main controller instance.

In some embodiments, the principle of minority following majority is used to evaluate the odd number of controller instances greater than one. A specific evaluation process may be that an average value of the output data of 5 controller instances is 62, assuming that an effectively range of the output data is −20 to 80, an evaluation standard is defined as 5% of the effective range, i.e. 5, and deviations between the output data of each controller instance and the average value are: 2.0, 2.1, 1.9, 2.0 and 8.0 respectively, where 8.0 is greater than the evaluation standard, and then the controller instances may respectively obtain score change values: 5, 5, 5, 5 and −5, the updated score values of the controller instances are: 100, 100, 100, 100 and 95, the controller instance with the highest score value may be selected as the main controller instance, the controller instance with the highest score value may be selected each time as the main controller instance, or one controller instance is preset as the main controller instance, and when its score value is smaller than the preset error score, the main controller instance is switched into the controller instance with the highest score value at that time.

An output step S104 including: outputting the output data of the main controller instance, and returning to the calculation step S102 for a new round of calculation.

In some embodiments, the data may be outputted based on a publish-subscribe pattern, the output data of the controller instance may be subscribed through the output module and outputted to the hardware.

In some embodiments, the virtual controller redundancy configuration method may include a controller instance error synchronization step S105, including: updating, in a case that the score value of one controller instance is lower than a preset error score, the intermediate data of the controller instance by the intermediate data of other controller instances, and updating an error count of the controller instance.

In some embodiments, the preset error score may be 60, the controller instance publishes the generated intermediate data after performing the calculation step S102, and subscribes the intermediate data of other controller instances for next calculation when the score value of the controller instance is lower than the preset error score.

In some embodiments, the virtual controller redundancy configuration method may include a controller instance error reset step S106, including: resetting, in a case that the error count of one controller instance reaches the preset number of error times, the score value and the error count of the controller instance, restarting the controller instance, and updating the intermediate data of the controller instance by the intermediate data of other controller instances.

In some embodiments, the preset number of error times may be 5, the score value of the controller instance is reset as 100 when resetting the controller instance, and the error count is reset as 0.

In some embodiments, the virtual controller redundancy configuration method may include a controller instance off-line reset step S107, including: resetting, in a case that the number of times that one controller instance does not generate output data reaches the preset number of off-line times, the score value and the error count of the controller instance, restarting the controller instance, and updating the intermediate data of the controller instance by the intermediate data of other controller instances.

In some embodiments, the preset number of off-line times may be 5.

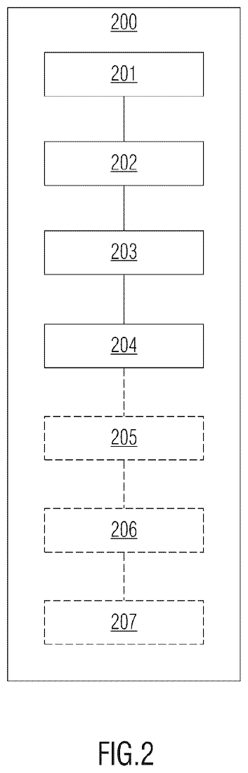

FIG. 2 is a schematic structural diagram of an example virtual controller redundancy configuration apparatus 200 incorporating teachings of the present disclosure. As shown in FIG. 2, the apparatus 200 may an include: initialization module 201, configured to: start at least one controller instance, and initialize a score value of the controller instance.

In some embodiments, when the controller instance is initialized and started, its score value may be a full score of 100 points, an upper limit is 100, and the quantity of the controller instances may be an odd number greater than 1, specifically 5.

A calculation module 202, configured to: acquire input data and intermediate data of each controller instance, obtain output data and new intermediate data of each controller instance by calculating respectively based on the input data and the intermediate data, and update the intermediate data by the new intermediate data.

In some embodiments, the data may be acquired based on a publish-subscribe pattern, the input data of the hardware may be received through an input module and published, the controller instance subscribes the input module to acquire the input data, and the output data of 5 controller instances specifically may be: 60, 59.9, 60.1, 60 and 70.

A controller instance selection module 203, configured to: evaluate the controller instances respectively based on the output data of each controller instance to obtain a score change value of each controller instance, update the score value of each controller instance according to the score change value, and select the controller instance with a highest score value as a main controller instance.

In some embodiments, the principle of minority following majority is used to evaluate the odd number of controller instances greater than one. A specific evaluation process may be that an average value of the output data of 5 controller instances is 62, assuming that an effectively range of the output data is −20 to 80, an evaluation standard is defined as 5% of the effective range, i.e. 5, and deviations between the output data of each controller instance and the average value are: 2.0, 2.1, 1.9, 2.0 and 8.0 respectively, where 8.0 is greater than the evaluation standard, and then the controller instances may respectively obtain score change values: 5, 5, 5, 5 and −5, the updated score values of the controller instances are: 100, 100, 100, 100 and 95, the controller instance with the highest score value may be selected as the main controller instance, the controller instance with the highest score value may be selected each time as the main controller instance, or one controller instance is preset as the main controller instance, and when its score value is smaller than the preset error score, the main controller instance is switched into the controller instance with the highest score value at that time.

An output module 204, configured to: output the output data of the main controller instance, and return to and execute the calculation module 202 for a new round of calculation.

In some embodiments, the data may be outputted based on a publish-subscribe pattern, the output data of the controller instance may be subscribed through the output module and outputted to the hardware.

In some embodiments, the virtual controller redundancy configuration apparatus may include a controller instance error synchronization module 205, configured to: update, in a case that the score value of one controller instance is lower than a preset error score, the intermediate data of the controller instance by the intermediate data of other controller instances, and update an error count of the controller instance.

In some embodiments, the preset error score may be 60, the controller instance publishes the generated intermediate data after executing the calculation module 202, and subscribes the intermediate data of other controller instances for next calculation when the score value of the controller instance is lower than the preset error score.

In some embodiments, the virtual controller redundancy configuration apparatus may include a controller instance error reset module 206, configured to: reset, in a case that the error count of one controller instance reaches the preset number of error times, the score value and the error count of the controller instance, restart the controller instance, and update the intermediate data of the controller instance by the intermediate data of other controller instances.

In some embodiments, the preset number of error times may be 5, the score value of the controller instance is reset as 100 when resetting the controller instance, and the error count is reset as 0.

In some embodiments, the virtual controller redundancy configuration apparatus may include a controller instance off-line reset module 207, configured to: reset, in a case that the number of times that one controller instance does not generate output data reaches the preset number of off-line times, the score value and the error count of the controller instance, restart the controller instance, and update the intermediate data of the controller instance by the intermediate data of other controller instances.

In some embodiments, the preset number of off-line times may be 5.

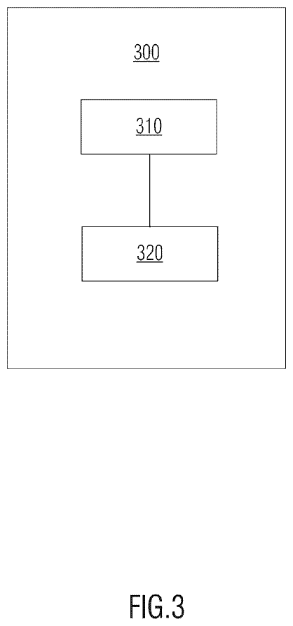

FIG. 3 is a schematic diagram of an example electronic device 300 incorporating teachings of the present disclosure. As shown in FIG. 3, the electronic device 300 includes a processor 310 and a memory 320. The memory 320 stores an instruction, and the instruction, when executed by the processor 310, implements one or more of the above mentioned virtual controller redundancy configuration methods. Some embodiments include a computer-readable storage medium, storing a computer instruction which, when run, executes one or more of the above mentioned methods and/or a computer program product, including a computer program, and the computer program, when executed by a processor, implements one or more of the above mentioned methods.

Some aspects of the method and apparatus of the present disclosure may be entirely executed by hardware, may be entirely executed by software (including firmware, resident software, microcode, and the like), or may be executed by a combination of hardware and software. The foregoing hardware or software may be referred to as “data block”, “module”, “engine”, “unit”, “component” or “system”. A processor may be one or more application specific integrated circuits (ASICs), digital signal processors (DSPs), digital signal processing devices (DSPDs), programmable logic devices (PLCs), field programmable gate arrays (FPGAs), processors, controllers, microcontrollers, microprocessors, or a combination thereof. In addition, various aspects of the present disclosure may be embodied as computer products located in one or more computer-readable media, the product including a computer-readable program code. For example, the computer-readable medium may include, but is not limited to, a magnetic storage device (for example, a hard disk, a floppy disk, a magnetic tape . . . ), an optical disk (for example, a compact disk (CD), a digital versatile disk (DVD) . . . ), a smart card, and a flash memory device (for example, a card, a stick, a key driver . . . ).

The flowchart is used to be configured to describe operations executed by the method according to the embodiments of this application herein. It should be understood that the foregoing operations may not necessarily be executed accurately according to the order. On the contrary, the various steps may be processed in a reverse order or simultaneously. At the same time, or other operations are added into these processes, or one or multiple operations are removed from these processes.

It should be understood that, although this specification is described according to each embodiment, each embodiment may not include only one independent technical solution. The description manner of this specification is merely for clarity. This specification should be considered as a whole by a person skilled in the art, and the technical solution in each embodiment may also be properly combined, to form other implementations that can be understood by a person skilled in the art.

The foregoing are merely specific schematic implementations of the present disclosure, and are not intended to limit the scope of the present disclosure. Any equivalent change, modification, and combination made by a person skilled in the art without departing from the conception and principles of the present disclosure should all fall within the protection scope of the present disclosure.

What is claimed is:

1. A virtual controller redundancy configuration method comprising:
starting at least one controller instance, and initializing a score value of the controller instance;
acquiring input data and intermediate data of each controller instance, obtaining output data and new intermediate data of each controller instance by calculating respectively based on the input data and the intermediate data, and updating the intermediate data by the new intermediate data;
evaluating the controller instances respectively based on the output data of each controller instance to obtain a score change value of each controller instance, updating the score value of each controller instance according to the score change value, and selecting the controller instance with a highest score value as a main controller instance;
outputting the output data of the main controller instance; and
repeating acquiring input data and succeeding limitations for a new round of calculations.

2. The method according to claim 1, further comprising
updating, in a case that the score value of one controller instance is lower than a preset error score, the intermediate data of the controller instance by the intermediate data of other controller instances, and updating an error count of the controller instance.

3. The method according to claim 2, further comprising
resetting, in a case that the error count of one controller instance reaches the preset number of error times, the score value and the error count of the controller instance, restarting the controller instance, and updating the intermediate data of the controller instance by the intermediate data of other controller instances.

4. The method according to claim 1, further comprising
resetting, in a case that the number of times that one controller instance does not generate output data reaches the preset number of off-line times, the score value and the error count of the controller instance, restarting the controller instance, and updating the intermediate data of the controller instance by the intermediate data of other controller instances.

5. A virtual controller redundancy configuration apparatus comprising:
an initialization module to: start at least one controller instance, and initialize a score value of the controller instance;
a calculation module to: acquire input data and intermediate data of each controller instance, obtain output data and new intermediate data of each controller instance by calculating respectively based on the input data and the intermediate data, and update the intermediate data by the new intermediate data;
a controller instance selection module to: evaluate the controller instances respectively based on the output data of each controller instance to obtain a score change value of each controller instance, update the score value of each controller instance according to the score change value, and select the controller instance with a highest score value as a main controller instance; and
an output module to: output the output data of the main controller instance, and return to and execute the calculation module for a new round of calculation.

6. The apparatus according to claim 5, further comprising
a controller instance error synchronization module to: update, in a case that the score value of one controller instance is lower than a preset error score, the intermediate data of the controller instance by the intermediate data of other controller instances, and update an error count of the controller instance.

7. The apparatus according to claim 6, further comprising
a controller instance error reset module to: reset, in a case that the error count of one controller instance reaches the preset number of error times, the score value and the error count of the controller instance, restart the controller instance, and update the intermediate data of the controller instance by the intermediate data of other controller instances.

8. The apparatus according to claim 5, further comprising
a controller instance off-line reset module to: reset, in a case that the number of times that one controller instance does not generate output data reaches the preset number of off-line times, the score value and the error count of the controller instance, restart the controller instance, and update the intermediate data of the controller instance by the intermediate data of other controller instances.

9-11. (canceled)
